(19) United States
(12) Patent Application Publication
(10) Pub. No.: US 2003/0140556 A1
(43) Pub. Date: Jul. 31, 2003

(54) Growing medium for plants

(76) Inventor: Christopher John Frogley, Dunollie (NZ)

Correspondence Address: Chester E Flavin, Esq., McCORMICK, PAULDING & HUBER LLP, City Place II, 185 Asylum Street, Hartford, CT, 06103-4102, US

(21) Appl. No.: 10/058,262

(22) Filed: Jan. 29, 2002

(51) Int. Cl. A01G 31/00

(52) U.S. Cl. 47/63

(57) ABSTRACT

A growing medium which consists of a self supporting block formed from sphagnum material bound together by a binding material dispersed through the sphagnum material; the binding material is a compatible adhesive.

### TECHNICAL FIELD

The present invention relates to a plant growing medium and to a method of manufacturing this medium.

### BACKGROUND ART

The requirements for a plant growing medium are as follows:

1. The medium must support the plant.

2. The medium must have adequate moisture retention properties, so that frequent watering is not required.

3. The medium must be sufficiently porous to allow excess water to drain away, allowing adequate aeration.

4. The medium should be capable of being cleaned without breaking down or deteriorating in any way, so that it can be supplied clean and free from weed seeds and other undesirable inclusions.

5. The medium should not have a high mineral content.

6. The medium should allow nutrients to remain available for plant use. The medium is not required to supply the nutrients, but it should not impede, or react with, the nutrients.

A wide variety of plant growing media currently are in use, including peat pots, blocks of foam plastics material, blocks of spun basalt, and plastics pots filled with particulate material such as perlite, vermiculite, or expanded clay. However, these media all have certain drawbacks:—peat has a relatively high tannin content, which can be undesirable for some uses; spun basalt is unpleasant to handle; both the foam plastics blocks and the spun basalt blocks are brittle and easily damaged, particularly when dry; the plastics pots filled with particulate materials are relatively expensive and labour-intensive, and some of the particulate materials produce dangerous dusts when dry and workers filling the pots need to wear breathing masks.

It is therefore an object of the present invention to provide a growing medium which fulfills the above requirements but which avoids the drawbacks of the currently used materials or at least provides the user with a useful choice.

A further object of the present invention is the provision of a growing medium which is suitable for all stages of plant growth (i.e. growing from seed/seedling development/propagation of cuttings/maintenance of mature plant growth) and which can be molded and/or cut into any required shape.

Another object of the present invention is the provision of a growing medium which can be produced in the form of a self supporting solid block of any desired shape. Thus, the growing medium can be used without an additional supporting plant pot if preferred.

### DISCLOSURE OF INVENTION

The present invention provides a growing medium comprising a self-supporting block formed from sphagnum material bound together by a binding material dispersed through the sphagnum material, said binding material being a compatible adhesive.

As used herein, the term “compatible adhesive” means an adhesive which does not degrade or disintegrate over the required period of use, which is non-toxic to the plants to be grown, and which is compatible with both the nutrients and the plant i.e. does not take up the nutrients or react with them, or inhibit plant growth in any way.

Preferably, the compatible adhesive can be prepared as an aqueous dispersion, for ease of mixing with the sphagnum material. Ethylene vinyl acetate (EVA) has been found very suitable as an adhesive.

The growing medium may also include fibrous material to increase the cohesion of the finished product. Suitable fibrous materials include carded wool and cellulose fibres e.g., paper pulp. Further, fibrous material may be used to form an exterior casing around the product.

The present invention provides a method for preparing a self-supporting block of growing medium comprising the steps of:

1. providing sphagnum material;

2. mixing a binding material with said sphagnum material;

3. transferring said mixture to a mould;

4. setting said binding material so that the binding material binds the sphagnum material;

5. removing the prepared block of growing medium from the mould.

Preferably the binding material is in the form of a liquid (typically an aqueous dispersion) and is mixed with the sphagnum material to form a slurry. The adhesive sets when the slurry dries. Alternatively, the binding material may be a melt bond powder which is mixed dry with the sphagnum material, and is set by heating.

### BRIEF DESCRIPTION OF THE DRAWINGS

By way of example only, preferred embodiments of the present invention are described in detail with reference to the accompanying drawings in which;

FIG. 1 is a cross-section of a single block of growing medium in accordance with the present invention;

FIG. 2 is a plan view of a multiple block of growing medium in accordance with the present invention;

FIG. 3 is a sectional side view of the block of FIG. 2, along line 3-3, and

FIGS. 4 & 5 are respectively plan and side views of a support frame.

### BEST MODE FOR CARRYING OUT THE INVENTION

Base Components

The predominant base component of the growing medium, which forms the major constituent of the growing medium, is sphagnum material. The sphagnum material may be sphagnum moss harvested in known manner, cleaned if necessary to remove weed seeds and other contaminants, chopped by passing through a shredder or auger, and dried.

Alternatively or additionally, the sphagnum material may be surplus or waste pieces of sphagnum moss which are by products from other sphagnum processing operations.

Shredded fibrous material (e.g. waste paper, wool, coconut fibre, shredded cork, shredded bark) may be mixed with the chopped sphagnum, to improve the strength of the finished product. The shredded fibrous material may be present up to about 5-20 percent by weight of the sphagnum material.

Additives such as fertilizers, (including slow release fertilizers) hormonal growth promoters, hydrated silica, and wetting agents also can be mixed with the sphagnum if required.

The sphagnum material, fibrous material, and additives can be cleaned to any required degree required by phytosanitary regulations (e.g. by fumigation or gamma irradiation); the materials may be cleaned individually, or after mixing, or after the finished product has been formed.

Binding Material

The binding material used must be a compatible adhesive, as defined above. A wide range of different types of adhesives can be used, for example:

Ethylene vinyl acetate based adhesives such as Peterson Chemicals Superflex 790G (TM),Bostik 33(TM), and Bostik WBA (TM) and Nyplex DM193(TM).

Animal or plant based adhesives such as casein, carotene, botanical gum resins.

Wax based adhesives, including petroleum wax based adhesives.

Thermoplastics including melt bond powders.

Most polyvinyl acetate based glues, and starch and paste glues, have been found insufficiently waterproof to be satisfactory for use in a hydroponics system. For use in systems other than hydroponics systems, a substantially non-waterproof binding material may be acceptable, particularly if the product is provided with an exterior coating or support frame as hereinafter described. However, if the product is to be used in a hydroponics system, the adhesives selected must be capable of withstanding prolonged saturation in a nutrient solution.

Preferably, the binding material selected is a water-based adhesive which can be prepared as a solution and mixed with the base material (sphagnum material alone or in combination with fibrous material and additives) to form a slurry which can be transferred into a mould to form any desired shape.

The product is allowed to dry in the mould, and as it dries it sets into the desired shape. Once dry, the adhesive is substantially waterproof.

Another possibility is to use a binding material in the form of a melt bond powder; this powder is mixed into the base component(s) so as to be evenly dispersed, the mixture is placed in a mould in the desired shape, and is then heated to melt the powder and bond the base material into the desired shape. However, heating degrades the sphagnum material, and so it is preferred to use a melt bond powder which can be activated at a temperature below 60° C., preferably below 45° C.

Coatings

As an optional addition, the product may be coated over all or part of its exterior, to make the product more resistant to abrasion and impact damage.

The following are suitable coating materials:

1. Fibrous material (e.g. waste paper, wool, coconut fibre, shredded cork, shredded bark). The fibrous material is mixed with one of the binding materials to form a slurry and is then used to line a mould. The slurry is allowed to dry and set before the mould is filled with a slurry of the base component/s mixed with the binding material. This results in a growing medium with an outer casing of fibrous material.

2. Fibrous material as in item 1 above is mixed with one of the binding materials to form a slurry which is then used to line the mould. However, rather than allowing this slurry to dry before adding the slurry of the base component/s, the slurry of the base component's mixed with the binding material is added immediately after the slurry of the fibrous material, and the two slurries dry simultaneously.

3. Melt bond casing. A melt bond powder (e.g. Mybond 30 (TM)) is used to line a mould and is heated to form an exterior casing around the block of growing material.

4. Spray on coating of sprayable thermoplastics.

5. Fabric wrap with an adhesive or melt bond coating e.g. polyester melt bond fibre (Mybond 30 (TM)), nylon MBPS—Mybond 40 (TM) or an emulsion adhesive coated LD Polyethylene.

6. Spray on coating of fibrous material mixed with one of the binding materials.

7. Shoot plastics wrap (e.g. polyethylene sheet).

8. Support frame as hereinafter described.

The coatings also aid liquid retention within the growing medium and can function as an insulating layer to provide an optimum micro-climate for plant root formation.

### EXAMPLE 1

To a base component of 13 grams of sphagnum material, with the optional addition of approximately 2.5 grams of fibrous material such as shredded wool or paper, is added a binding material in the form of 35 ml of ethylene vinyl acetate adhesive at 50 percent dilution. These components are thoroughly mixed (e.g. in mixer) to form a slurry and are placed in a mould of the desired final shape of the product. The slurry may be transferred to the mould manually or by auger feed or any other suitable known method. One or more apertures are formed in the upper finished surface of the slurry in the mould, using a mould template which is pressed onto the upper surface of the slurry in the mould; the application of the template lightly compresses the slurry;—typically, a mould plug 70 mm high would be reduced to approximately 40 mm high for the finished product.

The slurry is dried, either at ambient temperature or (at a temperature not greater than about 60° C.) in an oven or by forcing hot air through apertures in the template mould to speed drying.

Preferably, the slurry is dried using a forced hot air flow at about 45° C. with a flow rate of 12 cubic metres per minute at 100 mm water gauge.

The dried block of growing medium is removed from the mould and can be used in that state or can be coated over some or all of its surface using any of the coatings described above.

If desired, the growing medium can be cut or otherwise shaped before coating.

A dried block of size 500×250×40 mm typically weighs about 230 gm, i.e. the density of the dried product is about 0.046 gm/cm³.

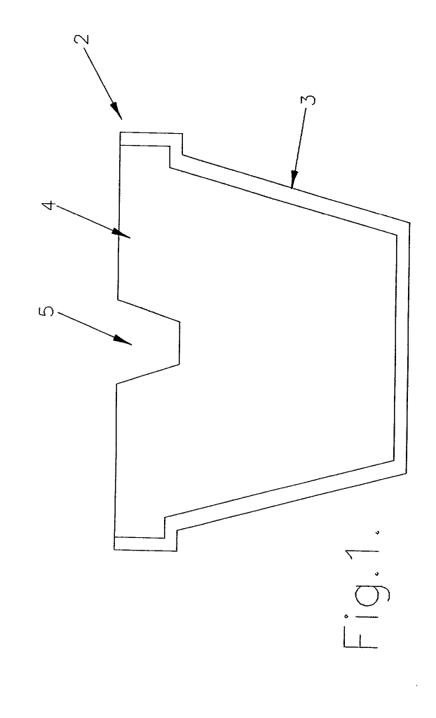

Referring to the drawings, FIG. 1 shows a single block 2 of growing medium in which the major portion of the block is formed from the base component 4 but with an exterior coating 3 applied around the base and sides of the block 2. The block is formed with aperture 5 for the insertion of a single seedling or cutting, either bare-rooted or already grown in a smaller block of growing medium; in the latter case, the smaller block of growing medium simply is plugged into the aperture 5 in the larger block.

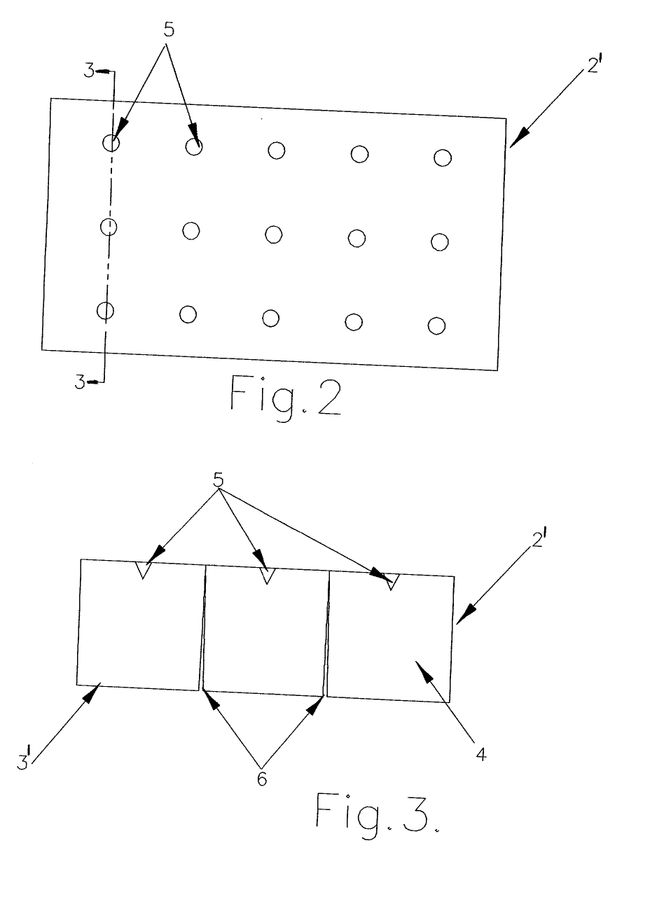

FIGS. 2 and 3 show a multiple block 2′ the underside 3′ of which has been cut by knife cuts 6 perform a series of joined but separable cubes, each of which is formed with a separate central aperture 5 for insertion of a seedling or cutting. This block is not provided with an exterior coating.

The exterior of the block may be coated with a contact adhesive so that the block can be secured onto a suitable support e.g. trellis or drift wood or a rock, for decorative effect.

Seeds may be sown directly into the block if desired.

### EXAMPLE 2

The mould used in Example 1 is formed with a coating before the slurry is placed in the mould. The coating is formed from a mixture of wool and/or coconut fibre formed into a slurry with one of the binding materials and allowed to set before the slurry for the block is poured into the mould.

This results in a block of the type shown in FIG. 1, with an exterior coating 3. In variations of this method, the coating slurry can be dried simultaneously with the slurry for the block itself; or the coating can be applied to the block after formation.

The above described growing medium may be used as a direct substitute for any of the existing growing media, in a variety of different applications including hydroponics.

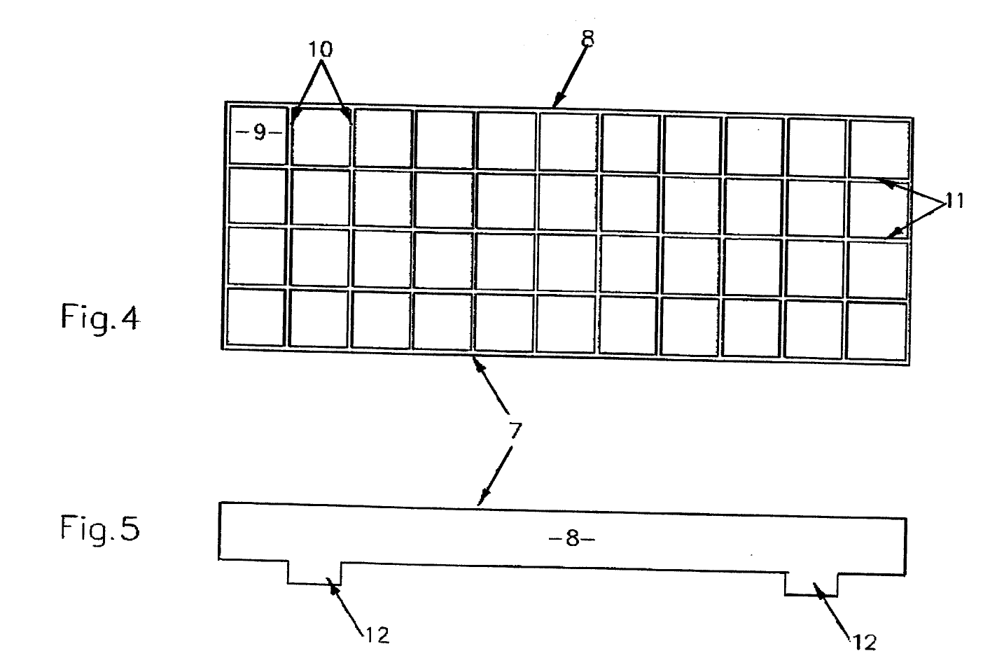

It will be appreciated that the growing medium formed in accordance with the present invention is relatively robust and is completely self-supporting, i.e. it does not need to be placed inside a pot or other support. However, it has been found that when a multiple block of the type shown in FIGS. 2 and 3 is used to grow seedlings, as the seedlings grow larger, the root system of one seedling can extend into adjacent blocks of growing medium. This is undesirable, because when the blocks of growing medium are separated, the roots tend to be damaged. To overcome this problem, it is advantageous to place the blocks of growing medium in a support tray of the type shown in FIGS. 4 and 5, for seedlings likely to have larger and more extensive root systems.

As shown in FIGS. 4 and 5, the support frame 7 comprises an outer rectangular frame 8 which is internally sub-divided into rows of square apertures 9 by two sets of spaced, parallel partitions, 10,11. The partitions 10,11 are equidistantly spaced and the partitions 10 are perpendicular to the partitions 11. Each aperture 9 is slightly larger than one of the small cubes of growing medium shown in FIG. 3, so that the cube is an easy sliding fit within the aperture 9. The partitions 10,11 extend the full depth of the support tray so that adjacent cubes of growing medium are effectively separated from each other over the root area of the seedling.

The tray is open at its lowest surface and is supported above a supporting surface by four equidistantly spaced legs 12, so that the cubes of growing medium supported in the frame can drain.

The support frame shown in FIGS. 4 and 5 may be used with a series of individual cubes of growing medium or a partially joined block of growing medium of the type described with reference to FIGS. 2 and 3 may be placed into the frame. It will be appreciated that the frame may be dimensioned to suit any sizes of block of growing medium.

1. A growing medium comprising a self-supporting block formed from sphagnum material bound together by a binding material dispersed through the sphagnum material, said binding material being a compatible adhesive, as hereinbefore defined.

2. The growing medium as claimed in claim 1 wherein the binding material is an adhesive in aqueous dispersion.

3. The growing medium as claimed in claim 2 wherein the binding material is ethylene vinyl acetate adhesive.

4. The growing medium as claimed in claim 1 wherein the binding material is selected from the following group:—casein, carotene, botanical gum resins, wax based adhesives, thermoplastics, thermoplastics melt bond powders.

5. The growing medium as claimed in claim 1 further comprising fibrous material dispersed through the sphagnum material.

6. The growing medium as claimed in claim 1 further comprising an exterior coating over all or part of said growing medium.

7. The growing medium as claimed in claim 6 wherein said exterior coating is selected from the group consisting of: fibrous material, thermoplastics melt bond powder, adhesive coated thermoplastics material.

8. The growing medium as claimed in claim 5 or claim 7 wherein said fibrous material is selected from the following group:—shredded waste paper, wool, coconut fibre, shredded cork, shredded bark.

9. A method for preparing a growing medium comprising the steps of:
providing sphagnum material;
mixing with said sphagnum material a binding material comprising a compatible adhesive, as hereinbefore defined;
transferring said mixture to a mould:
setting said binding material so that the binding material binds the sphagnum material to form a solid block;
removing the formed block from the mould.

10. The method as claimed in claim 9 wherein said binding material is an adhesive in aqueous dispersion and is mixed with the sphagnum material to form a slurry.

11. The method as claimed in claim 9 or claim 10 further comprising the step of providing fibrous material which is mixed with said sphagnum material.

12. The method as claimed in claim 9 further comprising the step of forming a coating around all or part of the exterior surface of said solid block.

13. The method as claimed in claim 12 wherein said exterior costing is selected from the group consisting of: fibrous material, thermoplastics melt bond powder, adhesive coated thermoplastics material.

14. The combination of a growing medium as claimed in any one of claims 1-8 and a support tray, said support tray providing one or more apertures, the or each aperture being adapted to receive the growing medium and being surrounded by solid side walls; the top and base of the or each aperture being open.
